(19) United States
(12) Patent Application Publication
(10) Pub. No.: US 2010/0204418 A1
(43) Pub. Date: Aug. 12, 2010

(54) Method for Producing Silane-Modified Copolymers

(76) Inventors: Laurent Marc, Hericy (FR); Michael Duetsch, Traunstein (DE); Helmut Mack, Traunstein (DE)

Correspondence Address: CURATOLO SIDOTI CO., LPA, 24500 CENTER RIDGE ROAD, SUITE 280, CLEVELAND, OH, 44145, US

(21) Appl. No.: 12/675,176

(22) PCT Filed: Sep. 1, 2008
(86) PCT No.: PCT/EP08/61493

§ 371 Date: Apr. 1, 2010

(30) Foreign Application Priority Data
Sep. 12, 2007 (DE) 10 2007 043 507.1
Oct. 18, 2007 (DE) 10 2007 049 859.6

(51) Int. Cl. C08F 2/00; C08F 230/08

(52) U.S. Cl. 526/87; 526/279

(57) ABSTRACT

The invention relates to a process for the preparation of a polymeric mixture, comprising a first polymerization step in which substantially monomer M is reacted by atom transfer radical polymerization in a mixture which contains a transition metal salt, a ligand having at least two chelating sites, an atom transfer radical polymerization initiator, a reducing agent and monomer M, and a second polymerization step in which monomer S substituted by silyl groups is added to the mixture obtained from the first polymerization step, so that monomer S substituted by silyl groups is reacted by atom transfer radical polymerization in the mixture obtained from the first polymerization step. The polymeric mixture obtained is used as a binder additive for sealants.

The present invention relates to a process for the preparation of a polymeric mixture, the polymeric mixture, a copolymer and the use of the polymeric mixture.

US-A-2006/0089431 states that silane-modified poly(meth)acrylates prepared by means of free radical polymerization have the disadvantage of mechanical properties which are not very satisfactory, in particular with regard to the elongation and adhesion properties, since the silyl groups present, which virtually act as anchor groups ensuring the adhesion between polymer and mineral surface (e.g. a concrete surface), are randomly distributed over the polymer obtained. An improvement in these properties can scarcely be achieved by preparation by means of free radical polymerization since this polymerization technique leaves only relatively little latitude for targeted design of the polymer architecture. Polymers having terminal or predominantly terminal silyl groups, i.e. polymers which at least very predominantly have one silyl group (or a plurality of silyl groups) at each polymer chain end, have, however, substantially better performance characteristics, in particular with regard to resilience and adhesion properties with respect to mineral substrate surfaces.

According to WO-A-2003091291, polymers terminated with silane modification in such a manner are produced in a relatively expensive manner in a plurality of steps, a silane-modifiable alkenyl prepolymer being prepared in a first step by means of so called Atom Transfer Radical Polymerization (ATRP).

This Atom Transfer Radical Polymerization (ATRP) is to be regarded as a quasi-living (pseudoliving) polymerization or as controlled free radical polymerization and differs from the (“conventional”) free radical polymerization substantially in that transfer reactions or chain termination reactions are suppressed to a high degree by the particular choice of the reagents and reaction conditions. However, this suppression does not in general take place completely since otherwise the case of a living polymerization would exist. The quasi-living polymerization makes it possible to avoid the disadvantages of living polymerization (limited possibility of choice with the monomers, complicated process engineering, sensitivity to soiling, etc.) and nevertheless has substantial advantages of living polymerization (relatively mild reaction conditions, controllable polymer architecture (e.g. block polymers can be prepared), polymers having a narrow molecular weight distribution).

The principle of ATRP is to be made clear by the following general scheme:

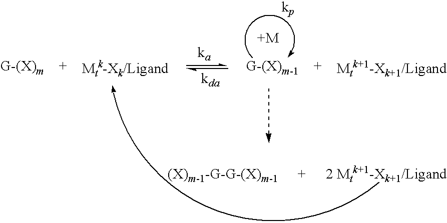

G-(X)ₘ: atom transfer radical polymerization initiator (ATRP initiator)
G: fragment of the ATRP initiator without transferable group
(X)ₘ: transferable group(s) with the number m (X is, for example, a halogen, e.g. Br)
Mₜ^{k}-Xₖ/ligand: ATRP catalyst (catalytically active form in the oxidation state k)
Mₜ^{k+1}-Xₖ₊₁/ligand: ATRP catalyst (oxidized, catalytically inactive form)
M: monomer
G-(X)ₘ₋₁: (macro)radical
(X)ₘ₋₁-G-(M)-G-(X)ₘ₋₁: reaction product of the chain termination
kₐ, k_{da}, kₚ, kₜ: rate constants of the activation, of the deactivation, of the chain growth (polymerization) and of the chain termination

What is decisive is that the atom transfer radical polymerization initiator G-(X)ₘ interacts with the ATRP catalyst (Mₜ^{k}-Xₖ/ligand) in such a way that free radicals form briefly and are subsequently “captured” again. The atom transfer radical polymerization initiator G-(X)ₘ may be present in the form of organic halogen compounds (X=(pseudo)halogen, e.g. Br or Cl), G representing a suitable organic radical. Mₜ^{k}-Xₖ/ligand represents a coordination compound of a transition metal Mₜ with a ligand which permits free radical formation by redox reaction. The atom transfer radical polymerization initiator reacts in a reversible manner (equilibrium) with production of a free radical species G^{o}-(X)ₘ₋₁ and the corresponding oxidized form of the catalyst (Mₜ^{k+1}-Xₖ₊₁/ligand) in the said redox reaction with the coordination compound (Mₜ^{k}-Xₖ/ligand). The free radical species G^{o}-(X)ₘ₋₁ produced initiates the polymerization of the monomer M with formation of G^{o}-(X)ₘ₋₁+M which, like G^{o}-(X)ₘ₋₁, is in equilibrium. The latter which is determined by the rate constants of the activation kₐ and of the deactivation k_{da}, is on the side of the atom transfer radical polymerization initiator species, which is variously also appropriately designated as “sleeping species”.

The average lifetime of the growing chain is very short (in the region of seconds) in the (“conventional”) free radical polymerization in contrast to the ATRP, since, after chain initiation is complete, the growth reaction takes place very rapidly before it is stopped by chain termination. In the case of the ATRP, on the other hand the reactive (macro) radical species is in equilibrium with the “sleeping species”, and the “sleeping species” is preferred in the equilibrium. The polymer chain accordingly grows “a little” after the formation of the (macro) radical species by polymerization of the monomer and then returns to the state of the “sleeping species”, this process being repeated constantly. The growing chains, which are in equilibrium with the sleeping species therefore have a long average lifetime (hours to years). Since this average lifetime of the growing chains and of the “sleeping species” in equilibrium with them is substantially longer in comparison with the (“conventional”) free radical polymerization, it is possible to control distribution of the monomer units in the polymer in a targeted manner by skilful addition of different types of monomers at different times. For example, with the aid of ATRP, it is possible to synthesize block copolymers by addition of different monomers in succession. One possibility for producing, for example, a block polymer of the structure type S-M-S is to use an atom transfer radical polymerization initiator having two transferable groups G-(X)₂ and first to carry out the polymerization of monomers of type M and then to finish the polymerization by addition of the monomer type S. However, it is possible for residual monomers of the type M also to be incorporated into the S blocks.

In contrast to the (“conventional”) free radical polymerization the relevant secondary reactions, in particular termination reactions, such as chain termination and chain transfer reactions, are greatly, but not completely, suppressed owing to the low concentration of G^{o}-(X)ₘ₋₁+M. The effect of termination reactions is that the coordination compound Mₜ^{k}-Xₖ/ligand required for the chain initiation is withdrawn from the system by irreversible shifting of the equilibrium in the direction of the oxidized form Mₜ^{k+1}-Xₖ₊₁/ligand. In other words an irreversible oxidation of the (co)catalysing coordination compound then takes place, which compound is then no longer available for catalysis, so that, in the extreme case, the polymerization comes to a stop as result of depletion of the reduced form. In order to counteract this in the case of the ATRP the coordination compound Mₜ^{k}-Xₖ/ligand is used in relatively large amounts in relation to the monomer M used. However, this means a deterioration in the quality of the polymer products obtained (e.g. undesired discolorations, which may necessitate expensive purification steps).

The abovementioned silane-modified alkenyl prepolymer prepared by means of Atom Transfer Radical Polymerization (ATRP) thus still contains considerable amounts of the said coordination compound. In subsequent process steps, hydrosilylation is effected with the use of a platinum catalyst, followed by further purification steps. This hydrosilylation step has a yield of only about 70-80%. and only 20-30% of the polymer chains obtained have less than two silyl groups. The multistage nature of the process and necessary, expensive working-up measures (in particular for freeing from the said coordination compound) of the polymer product reduce the economic attractiveness. As a result of the removal of the coordination compound, there is moreover the danger that the silane groups may be unintentionally destroyed since they are often sensitive, for example, to moisture.

The prepolymer obtained (e.g. XMAP® from Kaneka AG) can be used together with other prepolymers and epoxide-containing preparations, such as epoxy resins, epoxidized polysulphides, etc.

The object of the present invention is thus to prepare polymers terminated with silane modification in an economical process, which polymers are particularly suitable as additives for sealants and adhesives.

This object is achieved by a process for the preparation of a polymeric mixture, comprising

(i) a first polymerization step in which substantially monomer M is reacted by atom transfer radical polymerization in a mixture which contains a transition metal cation, a ligand having at least two chelating sites, an atom transfer radical polymerization initiator, a reducing agent and monomer M and
(ii) a second polymerization step in which monomer S substituted by silyl groups is added to the mixture obtained from the first polymerization step so that monomer S substituted by silyl groups is reacted by atom transfer radical polymerization in the mixture obtained from the first polymerization step,
the second polymerization step being initiated only when at least 50 mol % of the monomer M used altogether in the first polymerization step have been reacted beforehand by atom transfer radical polymerization, and the monomers M and S used being metered with the proviso that 1-1000 times more moles of monomer M are reacted by atom transfer radical polymerization in the first polymerization step than in comparison moles of monomer S by atom transfer radical polymerization in the second polymerization step,
the monomer M comprising ethylenically unsaturated compounds which are capable of undergoing atom transfer radical polymerization and have no silyl groups and the monomer S comprising ethylenically unsaturated compounds which are capable of undergoing atom transfer radical polymerization and contain in each case at least one silyl group.

In the process according to the invention, the so called Activator (Re)Generated by Electron Transfer Atom Transfer Radical Polymerization (A(R)GET ATRP) described in WO-A-2005 087819; in Shen et al., in Polymer Preprints 2006, 47(1). 156; in Macromolecules 2006, 39, 39-45; and in Macromolecules 2005, 38, 4139-4146—is used. In contrast to the ATRP described above, a reducing agent is additionally used for avoiding the high Mₜ^{k}-Xₖ/ligand concentrations in the case of A(R)GET ATRP. The reducing agent converts the oxidized species (Mₜ^{k+1}-Xₖ₊₁/ligand) into the reduced form (Mₜ^{k}-Xₖ/ligand) necessary for maintaining the polymerization. This ensures that even the use of only low concentrations of the species Mₜ^{k}-Xₖ/ligand (for example only a few ppm) is sufficient.

A further advantage of the use of A(R)GET ATRP over the use of ATRP is the relatively low sensitivity of the A(R)GET ATRP system to oxygen (for example from the air). In the most unfavourable case, the retardation of the “initiation” of the polymerization is to be feared. In contrast, an irreversible oxidation of the catalyst (Mₜ^{k}-Xₖ/ligand) would take place in the case of ATRP even in the presence of small amounts of oxygen and a polymerization would be ruled out. Nevertheless, in A(R)GET ATRP the atmospheric oxygen is usually roughly removed (possibly also application of a vacuum) by familiar methods, such as (repeated) flushing with nitrogen or other inert gases, or the use of dry ice. Incidentally, in the case of A(R)GET ATRP, the transition metal cations used were also used without problems in the higher oxidation states since the transition metal cations are reduced by the reducing agent. In the higher oxidation states, the transition metal cations are more stable to oxygen and often more economical.

In summary, it may be said that polymeric mixtures containing silane-modified poly(meth)acrylates can be synthesized by means of the process according to the invention in one stage and hence particularly economically. The amount of catalyst complex is so low that the expensive removal thereof is unnecessary and in particular no discolouration of the products is to be feared.

Regarding the reaction conditions under which the polymerization can take place, the following statements may be made. The polymerization can take place in the presence of one or more solvents. Not infrequently, additional cosolvents or surfactants, such as glycols or ammonium salts of fatty acids, are present. Most embodiments of the process according to the invention use no solvent or as little solvent as possible. Suitable organic solvents or mixtures of solvents are pure alkanes (hexane, heptane, octane, isooctane, etc.), aromatic hydrocarbons (benzene, toluene, xylene, etc.), esters (ethyl, propyl, butyl or hexyl acetate, fatty acid esters, etc.) and ethers (diethyl ether, dibutyl ether, etc.) or mixtures thereof. In the case of polymerizations in an aqueous medium, water-miscible or hydrophilic cosolvents may be added in order to ensure that the reaction mixture is present in the form of a homogeneous phase during the polymerization. Cosolvents which can be advantageously used for the present invention are selected from the group consisting of aliphatic ethers, glycol ethers, pyrrolidines, N-alkylpyrrolidinones, N-alkylpyrrolidones, amides, carboxylic acids and salts thereof, from esters, organosulphides, sulphoxides, sulphones, alcohol derivatives, hydroxyether derivatives, ketones and the like, and derivatives and mixtures thereof. As a further procedure, the polymerization can also be carried out in the absence of a solvent. Here, the reaction procedure and the reactor must be designed so that the heat of polymerization generated during the polymerization can be removed. Regarding the preferred polymerization temperature, the range from room temperature to about 150° C. is suitable, preferably from 50 to 120° C. and very particularly preferably from 60 to 100° C. Usually, the polymerization is carried out at atmospheric pressure. It should be stated that preferably both the first and the second polymerization step are carried out in the form of a mass polymerization in which substantially no solvent (frequently only a small amount of cosolvent) is used and the sum of the monomers M and monomers S used altogether comprises at least 80% by weight of the components used.

Monomers M particularly suitable for the process according to the invention are (meth)acrylic acid and/or derivatives thereof. Thus, usually at least 70% by weight of the monomers M used are present in the form of methacrylates and/or acrylates. This is intended to mean that advantageously a monomer mixture containing at least 70% by weight of (meth)acrylic monomers of the general formula

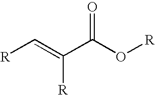

is used, where, in this general formula, R is identical or different and may represent hydrogen or a linear or branched, aliphatic or aromatic side chain having 1 to 30 C atoms. The side chain(s) are not especially limited with regard to their functional groups and functionalities such as, for example, alkyl, alkenyl (including vinyl), alkynyl (including acetylenyl), phenyl, amino, halogen, nitro, carboxyl, alkoxycarbonyl, hydroxyl and/or cyano, may be present. In the choice of the monomer M, it should in principle be noted that protic functions, such as hydroxyl, carboxyl, sulpho, etc., should not be present, or should be present only to a small extent, in the monomer mixture. The proportion of protic monomers should be less than 15 mol %, preferably less than 5 mol %, based on the total proportion of the monomer M.

Particularly preferred monomers M are methyl acrylate (MA), methyl methacrylate (MMA), ethyl acrylate (EA), n-butyl acrylate (n-BA), n-butyl methacrylate (n-BMA), tert-butyl acrylate (t-BA), tert-butyl methacrylate (t-BMA), 2-ethylhexyl acrylate (EHA), 2-ethylhexyl methacrylate (EHMA), isodecyl acrylate (i-DA), isodecyl methacrylate (i-DMA), lauryl acrylate (LA), lauryl methacrylate (LMA), stearyl acrylate (SA), stearyl methacrylate (SMA), isobornyl acrylate, isobornyl methacrylate, cyclohexyl acrylate, cyclohexyl methacrylate, dimethylaminoethyl methacrylate (DMAEMA), cyanoacrylates, citraconate, itaconate and derivatives thereof.

In addition to the abovementioned (meth)acrylic acid derivatives dienyl or vinyl compounds in a proportion of up to preferably not more than 30% by weight may also be used—in particular one or more vinyl compounds selected from the group consisting of vinyl acetate, vinyl ketones, N-vinylformamide, vinylpyridine, vinyl N-alkylpyrrole, vinyloxazole, vinylthiazole, vinylpyrimidine, vinylimidazoles, ethyl vinyl ether, acrylamide, fumaric acid, maleic anhydride, styrene and derivatives thereof.

The first polymerization step can be subdivided into a plurality of part-steps, in each of which different monomers M are reacted by atom transfer radical polymerization, so that block copolymer-like chain segments are formed.

The monomer S substituted by silyl groups is preferably present according to the general formula L-(CH₂)ₙSiR³ₚR⁴₃₋ₚ

where
L is represented by

### CH═CH₂, O—CO—C(CH₃)═CH₂, or

### O—CO—CH═CH₂,

in which
R³ are identical or different and are represented by a branched or straight-chain alkyl group having 1 to 18 carbon atoms, a cyclic alkyl group having 1 to 18 carbon atoms, an aryl group having 1 to 18 carbon atoms and/or an arylalkyl group having 1 to 18 carbon atoms.
R⁴ are identical or different and are represented by
—(CH₂—CH₂—O)ₘ—R³, —(CH₂—CHR³—O)ₘ—R³, —OR³, —NR³R³, —O—N═CR³R³, —O—COR³ and/or NH—COR³,
where
n=an integer from 0 to 10,
m=an integer from 1 to 50 and
p=0, 1, 2 or 3.

In the case of a polymerization in an aqueous medium it should be noted that the monomer S used should have silyl groups stable to water, such as —Si(O-isopropyl)₃.

In a preferred embodiment of the invention, at least 20 mol % of the monomer S reacted by atom transfer radical polymerization in the second polymerization step have trimethoxy- and/or triethoxy-substituted silyl groups. Particularly preferred monomers S of this type are, for example, (3-methacryloyloxypropyl)trimethoxysilane, (3-methacryloyloxypropyl)triethoxysilane or (methacryloyloxymethyl)-trimethoxysilane. As a result, the adhesion properties and the resilience of the copolymer obtained or of the polymeric mixture obtained are further improved.

The structure of the monomers S (in particular the chemical environment of the double bond) very substantially influences the polymerization behaviour of the monomers S. A distinction is made between so-called telechelic copolymers which have a silane group at each end of the polymer and so-called pseudotelechelic polymers which have a plurality of silane groups in the vicinity of the polymer ends. Telechelically directing monomers S stop the polymerization after the incorporation of a monomer unit S into the copolymer chain, so that in each case only one structural unit of the monomer S is incorporated at the copolymer ends. In the case of the pseudotelechelic copolymers one or more structural units of the monomer S are incorporated, depending on the conditions. Residual monomer M which may still be available in the system may also be incorporated. This is shown schematically below with reference to examples:

a.) telechelic
S-(M)_{d}-S
   b.) pseudotelechelic (examples)
SS-(M)_{d}-S
SS-(M)_{d}-SS
SS-(M)_{d}-SMS
MSS-(M)_{d}-SMS

Examples of monomers S which lead to telechelic copolymers are allyl derivatives (e.g. CH₂═CH—CH₂—SiR³ₚR⁴₃₋ₚ). (Meth)acrylic derivatives (e.g. CH₂═CH—COO—(CH₂)₃—SiR³ₚR⁴₃₋ₚ or CH₂═CMe—COO—(CH₂)₃—SiR³ₚR⁴₃₋ₚ) direct the formation of pseudotelechelic copolymers.

Thus, in a particularly preferred embodiment, the monomer S used is selected so that, after its reaction by atom transfer radical polymerization, it directs the production of pseudotelechelic and/or telechelic chains.

In a customary procedure, in the process according to the invention, the second polymerization step is initiated only when at least 70 mol %, preferably at least 90 mol %, of the monomer M used altogether in the first polymerization step have been reacted beforehand by atom transfer radical polymerization. Furthermore, a procedure is generally adopted in which, in the first polymerization step, 2 to 100 times, preferably 10 to 50 times, more moles of monomer M are reacted by atom transfer radical polymerization than in comparison moles of monomer S by free radical polymerization in the second polymerization step.

As already explained above, a transition metal cation is used as a catalyst for carrying out the polymerization.

Usually, at least one transition metal cation from the group consisting of Cu, Fe, Ru, Cr, Co, Ni, Sm, Mn, Mo, Pd. Pt, Re, Rh, Ir, Sb and/or Ti, preferably Cu, Fe or Ru, is used.

These transition metal cations can be used both individually and as a mixture. It is assumed that the transition metal cations catalyse the redox cycles of the polymerization for example the redox pair Cu²⁺/Cu⁺ or Fe³⁺/Fe²⁺ being active. In general, transition metal salts are used as a source of the transition metal cations—frequently present as halide, such as chloride or bromide, as alkoxide, hydroxide, oxide, sulphate, phosphate or hexafluorophosphate, and/or as trifluoromethanesulphate. The preferred species include the transition metal salts in higher oxidation states, such as CuO, CuBr₂, CuCl₂, Cu(SCN)₂, Fe₂O₃, FeBr₃, RuBr₃, CrCl₃ and NiBr₃ (the reducing agent used effects the reduction to the suitable oxidation state). The transition metal salts can also be added in a lower oxidation state. However, such species are unstable and less economical.

Regarding the relative proportion of the transition metal cation it may be said that the monomer M is preferably used in a molar ratio to the transition metal cation of 10² to 10⁸, preferably 10⁴ to 10⁶, particularly preferably 10⁵ to 10⁶.

The polymerization takes place in the presence of bidentate or polydentate ligands which can form a coordination compound (complex) with the transition metal cation. These ligands serve, inter alia, for increasing the solubility of the transition metal compound. A further important function of the ligands consists in the avoidance of the formation of stable organometallic compounds. This is particularly important since these stable compounds would not be suitable as a polymerization catalyst under the chosen reaction conditions. Furthermore, it is assumed that the ligands facilitate the abstraction of the transferable atomic group. Suitable ligands according to the invention generally have one or more nitrogen, oxygen, phosphorus and/or sulphur atoms, via which the transition metal cation can be linked by a coordinate bond.

Particularly preferred ligands are chelate ligands which contain N atoms. These include, inter alia, 2,2′-bipyridine, alkyl-2-2′-bipyridine, such as 4,4′-di(5-nonyl)-2,2′-bipyridine, 4,4′-di(5-heptyl)-2,2′-bipyridine, hexamethyl tris(2-aminoethyl)amine (Me₆TREN), N,N,N′,N″,N″-pentamethyldiethylenetriamine (PMDETA), 1,1,4,7,10,10-hexamethyltriethylenetetramine (HMTETA), N,N,N′,N′-tetra[(2-pyridal)methyl]ethylenediamine (TPEN) and/or tetramethylethylenediamine. The ligands can be used individually or as a mixture.

The ligands may form coordination compounds by in situ reaction with transition metal salts (halides, oxides, sulphates, phosphates . . . ) or the coordination compounds can first be synthesized and then added to the reaction mixture. The ratio of ligand to transition metal cation is dependent on the denticity of the ligand and the coordination number of the transition metal.

Expediently, the transition metal cation is used in a molar ratio to the ligand having at least 2 chelating sites of 0.01 to 10, preferably 0.1 to 8, particularly preferably 0.3 to 3.

Preferably, the atom transfer radical polymerization initiator used is present according to the general formula

G-(X)ₘ

where
X are identical or different and are represented by a halogen atom, preferably Cl and Br, and/or a pseudohalogen group, preferably SCN, m being an integer, preferably 1 to 6, particularly preferably 2.

If m were to be a high number, this would lead to dentritic polymers. m is the number of transferable groups or “arms of the polymer” and not the number of (pseudo)halogen groups. If m is 1, the atom transfer radical polymerization initiator is monofunctional—the polymer chain grows only in one direction. If m is 2, the preferred case of bifunctional atom transfer radical polymerization initiators is present. Functionalization is then possible at both polymer ends.

CHCl₃ is, for example, a monofunctional initiator and is indicated schematically as G-(X). Dimethyl-2,6-dibromoheptanedioate

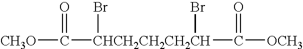

is a bifunctional atom transfer radical polymerization initiator and is represented schematically as G-(X)₂.

G is present as a molecular fragment which contributes to the stabilization of free radicals and has no transferable group.

In other words, G represents the fragment of the initiator without the transferable groups, which acts as an initiator of the polymerization with formation of a free radical, undergoes an addition reaction with an ethylenically unsaturated compound and is incorporated into the polymer. There are no special limitations with regard to G, but the radical G should preferably have substituents which can stabilize free radicals. Such substituents are frequently —CN, —COR′, —CO₂R′, R′ representing an alkyl, aryl and/or heteroaryl radical. Suitable alkyl radicals are saturated or unsaturated, branched or linear hydrocarbon radicals having 1 to 40 carbon atoms, such as, for example, methyl, ethyl, propyl, butyl, pentyl, 2-methylbutyl, pentenyl, cyclohexyl, heptyl, 2-methylheptenyl, 3-methylheptyl, octyl, nonyl, 3-ethylnonyl, decyl, undecyl, 4-propenylundecyl, dodecyl, tridecyl, tetradecyl, pentadecyl, hexadecyl, heptadecyl, octadecyl, nonadecyl, eicosyl, cetyleicosyl, docosyl and/or eicosyltetratriacontyl. Suitable aryl radicals are aromatic radicals which have 6 to 14 carbon atoms in the aromatic ring and may be substituted. Substituents are, for example, linear and branched alkyl groups having 1 to 6 carbon atoms, such as, for example, methyl, ethyl, propyl, butyl, pentyl, 2-methylbutyl or hexyl, cycloalkyl groups, such as, for example cyclopentyl and cyclohexyl, aromatic groups, such as phenyl or naphthyl, amino groups, ether groups, ester groups and halides. Examples of aromatic radicals are phenyl, xylyl, toluoyl, naphthyl or biphenyl. Suitable heteroaryl groups are heteroaromatic ring systems in which at least one CH group is replaced by N or two neighbouring CH groups are replaced by S, O or NH, such as a radical of thiophene, furan, pyrrole, thiazole, oxazole, pyridine, pyrimidine and benzo(a)furan, which can likewise have the abovementioned substituents.

The transferable atom X is particularly preferably present in the form of Br and/or Cl. Examples of atom transfer radical polymerization initiators are alkyl halides (e.g. CHCl₃, CCl₄, CBr₄, CBrCl₃), benzyl halides (e.g. Ph₂CHCl, Ph₂CCl₂, PhCCl₃), (ethylbromoisobutyrate (EBIB), CCl₃CO₂CH₃, CHCl₂CO₂CH₃, ethylene glycol dibromoisobutyrate (EGBIB), butanediol dibromoisobutyrate (BDBIB)). CCl₃COCH₃, CHCl₂COPh, 2-bromopropionitrile, sulphonyl halide (e.g. mesyl chloride (CH₃SO₂Cl), tosyl chloride (CH₃PhSO₂Cl) and chlorosulphonyl isocyanate (Cl—SO₂—N═C═O) derivatives).

In order finally to obtain polymers having a silyl group at least two polymer ends bifunctional atom transfer radical polymerization initiators are usually required. Particularly preferred examples thereof are CCl₄, dimethyl 2,6-dibromoheptanedioate (DMDBHD)

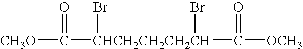

or diethyl meso-2,5-dibromoadipate (DEDBA)

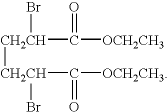

Advantageously, the transition metal salt is used in a molar ratio to the atom transfer radical polymerization initiator of 10⁻⁴ to 0.5, preferably 10⁻³ to 0.1, particularly preferably 10⁻³ to 10⁻².

A substantial criterion for the choice of the reducing agent is that it is capable of reducing the oxidized species transition metal cation/ligand (Mₜ^{k+1}-Xₖ₊₁/ligand) so that as far as possible no free radicals are produced or that transition metal cation/ligand (Mₜ^{k+1}-Xₖ₊₁/ligand) is always present. This is desirable in order to avoid polymerizations which do not take place in accordance with the A(R)GET ATRP mechanism. When choosing suitable reducing agents, it should also as far as possible be ensured that the reducing agent is sufficiently soluble in the respective polymerization system.

Reducing agents which may be used are organic or inorganic reagents, such as, for example, tertiary amines, in particular triethylamine or tributylamine, tin compounds, such as tin 2-ethylhexanoate (Sn(2EH)₂) or tin oxalate, sodium sulphite, further sulphur compounds in lower oxidation states, ascorbic acid, ascorbic acid 6-palmitate, inorganic iron salts, hydrazine hydrate, alkylthiols, mercapto alcohols, enolisable carbonyl compounds, acetyl acetonate, camphor sulphonic acid, hydroxyacetone, reducing sugars, glucose and similar sugars, monosaccharides, tetrahydrofuran, dihydroanthracene, silanes, 2,3-dimethylbutadiene, amines, polyamines, hydrazine derivatives, formamidinesulphonic acid, boranes, aldehydes and/or derivatives thereof.

Regarding the quantitative part of the reducing agent, it may be said that the reducing agent is usually used in a molar ratio to the transition metal cation of 1 to 10⁷, preferably 1 to 10⁵, particularly preferably 1 to 10³.

The invention also relates to a polymeric mixture which can be prepared according to the process described above and comprises a copolymer having trimethoxy- and/or triethoxy-substituted silyl groups.

The last-mentioned copolymer, too, is provided according to the invention.

The polymeric mixture described above is used according to the invention as a binder additive for a sealant or an adhesive (e.g. a tile adhesive).

Below, the invention is to be explained in more detail with reference to working examples.

### EXAMPLE 1 (E1)

### Pseudotelechelic silane-modified copoly(n-butyl acrylate, n-butyl methacrylate) in the Absence of a Solvent

400.00 g of n-butyl acrylate (Chemical Abstracts Service (CAS) 141-32-2) and 50.00 g of n-butyl methacrylate (CAS 97-88-1) are introduced into a 500 ml glass flask equipped with a mechanical stirrer, with a nitrogen/vacuum inlet, with a pressure relief valve and with a thermocouple. A mixture of 90 mg of transition metal salt copper(II) bromide (CAS 7789-45-9) and 180 mg of ligand TPEN (N,N,N′,N′-tetra[(2-pyridal)methyl]ethylenediamine, CAS 16858-02-9) in a little N-ethylpyrrolidone (CAS 2687-91-4) is then added. Rough inertization is effected with nitrogen/vacuum while stirring. 250 mg of reducing agent Sn(2EH)₂ (tin di-2-ethylhexanoate, CAS 301-10-0) are then added. The mixture is heated to 80° C. After 15 minutes, 4.0 g of difunctional initiator DMDBHD (dimethyl dibromoheptanedioate, CAS 868-73-5) are added in order to initiate the polymerization. After 4 hours, 30.0 g of Dynasilan® MEMO (3-methacryloyl-oxypropyl)trimethoxysilane, CAS 2530-85-0) are added. After 2 hours the residual monomer is boiled in vacuo and the prepolymer is filled.

### Result:

The amount of catalyst complex is so low that the expensive removal thereof is unnecessary. The process is a one-stage process and is carried out in a customary reactor without particular inertization, with the result that the process is highly attractive in economic terms.

### EXAMPLE 2 (E2)

### Pseudotelechelic Silane-Modified Copolyacrylate with Plasticizer

90.00 g of an acrylate mixture (50 g of n-butyl acrylate (CAS 141-32-2), 20 g of ethyl acrylate (CAS 140-88-5), and 20 g of ethyldiglycol acrylate, (CAS 32002-24-7)) and 30 g of plasticizer DIUP (diisoundecyl phthalate, CAS 85507-79-5) are introduced into a 250 ml glass flask equipped with a mechanical stirrer, with a nitrogen/vacuum inlet, with a pressure relief valve and with a thermocouple. A mixture of 10 mg of transition metal salt copper(II) bromide (CAS 7789-45-9) and 30 mg of ligand TPEN (N,N,N′,N′-tetra[(2-pyridal)methyl]ethylenediamine, CAS 16858-02-9) in 10 g of n-butyl acrylate is then added. Rough inertization is effected with dry ice/nitrogen/vacuum with stirring. 55 mg of reducing agent Sn(2EH)₂ (tin di-2-ethylhexanoate. CAS 301-10-0) are added. The mixture is heated to 80° C. After 15 minutes, 0.50 g of difunctional initiator DEDBHD (diethyl dibromoheptanedioate, CAS 868-68-8) is added in order to initiate the polymerization. After 4 hours 4.0 g of Silquest A-174 (3-methacryloyloxypropyl)trimethoxysilane, CAS 2530-85-0) are added. After 2 hours, the residual monomer is boiled in vacuo and the prepolymer is filled. The amount of catalyst complex is so low that the expensive removal thereof is unnecessary.

### Result:

The process is carried out in one stage in a customary reactor without particular inertization and is therefore particularly economical.

### COMPARATIVE EXAMPLE 1 (CE1)

### Random Silane-Modified poly(n-butyl acrylate)

50.00 g of plasticizer DIUP (diisoundecyl phthalate, CAS 85507-79-5) are initially introduced into a 500 ml glass flask equipped with a mechanical stirrer, with a nitrogen/vacuum inlet, with a pressure relief valve and with a thermocouple and are heated to 160° C. A mixture of 450.00 g of n-butyl acrylate (CAS 141-32-2), 9.0 g of KBM-503 (3-methacryloyloxypropyl)tri-methoxysilane, CAS 2530-85-0) and 1.0 g of diazo initiator VAZO 52 (CAS 4419-11-8) is metered in under nitrogen in 4 hours. After 2 hours, the residual monomer is boiled in vacuo and the colourless prepolymer is filled.

### COMPARATIVE EXAMPLE 2 (CE2)

### No Reducing Agent

90.00 g of an acrylate mixture (50 g of n-butyl acrylate (CAS 141-32-2), 20 g of ethyl acrylate (CAS 140-88-5), and 20 g of ethyldiglycol acrylate (CAS 32002-24-7)) and 30 g of plasticizer DIUP (diisoundecylphthalate, CAS 85507-79-5) are introduced into a 250 ml glass flask equipped with a mechanical stirrer, with a nitrogen/vacuum inlet, with a pressure relief valve and with a thermocouple. A mixture of 10 mg of transition metal salt copper(II) bromide and 30 mg of ligand TPEN (N,N,N′,N′-tetra[(2-pyridal)methyl]ethylene-diamine, CAS 16858-02-9) in 10 g of n-butyl acrylate (CAS 141-32-2) is then added. Rough inertization is then effected with dry ice/nitrogen/vacuum while stirring. The mixture is heated to 80° C. After 15 minutes, 0.50 g of difunctional initiator DEDBHD (diethyl dibromoheptanedioate, CAS 868-68-8) is added in order to initiate the polymerization. After 10 hours, the reducing agent is still completely liquid: no polymerization has taken place. The silylated monomer was not added.

### COMPARATIVE EXAMPLE 3 (CE3)

### Pseudotelechelic Silane-Modified poly(n-butyl acrylate) with ATRP

44 g of acetonitrile (CAS 75-05-8) and 100.00 g of n-butyl acrylate (CAS 141-32-2) are introduced into a 500 ml glass flask equipped with a mechanical stirrer, with a nitrogen/vacuum inlet, with a pressure relief valve and with a thermocouple. 4.2 g of copper(I) bromide (CAS 7789-70-4) and 0.17 g of PMDETA (pentamethyldiethylenetriamine, CAS 3030-47-5) are then added. Inertization is then effected with nitrogen/vacuum while stirring. The mixture is heated to 70° C. 8.8 g of difunctional initiator DEDBA (diethyl meso-2,5-dibromoadipate, CAS 869-10-3) are then added in order to initiate the polymerization. 400.00 g of n-butyl acrylate are added continuously in portions with 0.68 g of triethylamine. After 6 hours, 11.0 g of Dynasilan® MEMO (3-methacryloyloxypropyl)trimethoxysilane, CAS 2530-85-0) are added. After 2 hours, the residual monomer, acrylonitrile and triethylamine are boiled in vacuo.

### Result:

The amount of catalyst complex is so high that the prepolymer is strongly discoloured. Expensive removal is necessary. The process is a multistage process and is not to be regarded as being economical. Crosslinked prepolymer is present, as in the other experiments.

### Customary Formulation of Known Prepolymers:

| Raw material | | % by weight |
|---|---|---|
| Pseudotelechelic | Binder | 30.0 |
| silylated polyacrylates | | |
| Jayflex DIUP | Plasticizer | 15.0 |
| Socal U1S2 | Calcium carbonate | 38.2 |
| Omyacarb VP OM 510 | Precipitated calcium | 7.5 |
| | carbonate | |
| Tronox 435 | Pigment | 4.0 |
| Dynasylan VTMO | Water scavenger | 3.0 |
| Dynasylan AMMO | Adhesion promoter | 1.0 |
| Dispalon 6500 | Thixotropic agent | 0.6 |
| Sanol LS765 | Light stabilizer | 0.3 |
| Tinuvin 213 | UV absorption | 0.3 |
| BNT-CAT 440 | Tin catalyst | 0.1 |

The plasticizer can be added during the formulation or during the prepolymer synthesis.

### Tensile Strength and Elongation:

| | E1 | CE1 | E2 |
|---|---|---|---|
| 50% modulus | 0.3 | 0.2 | 0.6 |
| (MPa) | | | |
| 100% modulus | 0.4 | 0.3 | 0.9 |
| (MPa) | | | |
| Tensile strength | 0.4 | 0.3 | 1.1 |
| (MPa) | | | |
| Elongation (%) | 60 | 50 | 190 |

All formulations except for CE3 are white. Owing to the strong discolouration, CE3 is unsuitable. CE2 is likewise unsuitable because polymerization has not taken place. Example CE1 shows that the known, randomly silylated polyacrylates do not have particularly good mechanical properties. A substantial improvement is shown with Example E2, in the form of economical, low-colour, pseudotelechelic, silylated polyacrylate.

1. Process for the preparation of a polymeric mixture, comprising
(i) a first polymerization step in which substantially monomer M is reacted by atom transfer radical polymerization in a mixture which contains a transition metal cation, a ligand having at least two chelating sites, an atom transfer radical polymerization initiator, a reducing agent and monomer M and
(ii) a second polymerization step in which monomer S substituted by silyl groups is added to the mixture obtained from the first polymerization step so that monomer S substituted by silyl groups is reacted by atom transfer radical polymerization in the mixture obtained from the first polymerization step,
the second polymerization step being initiated only when at least 50 mol % of the monomer M used altogether in the first polymerization step have been reacted beforehand by atom transfer radical polymerization, and the monomers M and S used being metered with the proviso that 1-1000 times more moles of monomer M are reacted by atom transfer radical polymerization in the first polymerization step than in comparison moles of monomer S by atom transfer radical polymerization in the second polymerization step,
the monomer M comprising ethylenically unsaturated compounds which are capable of undergoing atom transfer radical polymerization and have no silyl groups and the monomer S comprising ethylenically unsaturated compounds which are capable of undergoing atom transfer radical polymerization and contain in each case at least one silyl group.

2. Process according to claim 1, characterized in that the second polymerization step is initiated only when at least 70 mol %, optionally at least 90 mol %, of the monomer M used altogether in the first polymerization step has been reacted beforehand by atom transfer radical polymerization.

3. Process according to claim 1, characterized in that, in the first polymerization step, 2 to 100 times, optionally 10 to 50 times, more moles of monomer M are reacted by atom transfer radical polymerization than in comparison moles of monomer S by free radical polymerization in the second polymerization step.

4. Process according to claim 1, characterized in that the monomer M is used in a molar ratio to the transition metal cation of 10² to 10⁸, optionally 10⁴ to 10⁶, further optionally 10⁵ to 10⁶.

5. Process according to claim 1, characterized in that the transition metal cation is used in a molar ratio to the ligand having at least 2 chelating sites of 0.01 to 10, optionally 0.1 to 8, further optionally 0.3 to 3.

6. Process according to claim 1, characterized in that the transition metal cation is used in a molar ratio to the atom transfer radical polymerization initiator of 10⁻⁴ to 0.5, optionally 10⁻³ to 0.1, further optionally 10⁻³ to 10⁻².

7. Process according to claim 1, characterized in that the reducing agent is used in a molar ratio to the transition metal cation of 1 to 10⁷, optionally 1 to 10⁵, further optionally 1 to 10³.

8. Process according to claim 1, characterized in that the first and second polymerization steps are carried out in the form of a mass polymerization in which substantially no solvent is used and the sum of the monomers M and monomers S used altogether comprises at least 80% by weight of the components used.

9. Process according to claim 1, characterized in that at least 70% by weight of the monomer M used is present in the form of methacrylates and/or acrylates.

10. Process according to claim 1, characterized in that the monomer S substituted by silyl groups is present according to the general formula L-(CH₂)ₘSiR³ₚR⁴₃₋ₚ,
where
L is represented by CH═CH₂, O—CO—C(CH₃)═CH₂, or O—CO—CH═CH₂,
in which
R³ are identical or different and are represented by a branched or straight-chain alkyl group having 1 to 18 carbon atoms, a cyclic alkyl group having 1 to 18 carbon atoms, an aryl group having 1 to 18 carbon atoms and/or an arylalkyl group having 1 to 18 carbon atoms.
R⁴ are identical or different and are represented by
—(CH₂—CH₂—O)ₘ—R³, —(CH₂—CHR³—O)ₘ—R³, —OR³, —NR³R³, —O—N═CR³R³, —O—COR³ and/or —NH—COR3,
where
n=an integer from 0 to 10,
m=an integer from 1 to 50 and
p=0, 1, 2 or 3.

11. Process according to claim 1, characterized in that the monomer S used is chosen so that, after the reaction thereof by atom transfer radical polymerization, it directs the production of pseudotelechelic and/or telechelic chains.

12. Process according to claim 1, characterized in that the transition metal cation used is at least one selected from the group consisting of Cu, Fe, Ru, Cr, Co. Ni, Sm, Mn, Mo, Pd, Pt, Re, Rh, Ir, Sb and Ti, optionally Cu, Fe or Ru.

13. Process according to claim 1, characterized in that the atom transfer radical polymerization initiator used is present according to the general formula
G-(X)ₘ
where
X are identical or different and are represented by a halogen atom, optionally Cl and/or Br, and/or a pseudohalogen group, optionally SCN, m being an integer, optionally 1 to 6, further optionally 2, and
G being present as a molecular fragment which contributes to the stabilization of free radicals and has no transferable group.

14. Process according to claim 1, characterized in that the reducing agent used is chosen so that it produces no free radicals during the first and second polymerization steps.

15. Process according to claim 1, characterized in that the first polymerization step is subdivided into a plurality of part-steps, in each of which different monomers M are reacted by atom transfer radical polymerization, so that block copolymer-like chain segments are formed.

16. Process according to claim 1, characterized in that at least 20 mol % of the monomer S reacted by atom transfer radical polymerization in the second polymerization step have trimethoxy- and/or triethoxy-substituted silyl groups.

17. Polymeric mixture prepared by the process according to claim 16.

18. Copolymer which is present in the polymeric mixture according to claim 17 and has trimethoxy- and/or triethoxy-substituted silyl groups.

19. A process comprising providing the polymeric mixture according to claim 17 and incorporating the polymeric mixture as a binder additive for a sealant or an adhesive.
